(19) United States
(12) Patent Application Publication
(10) Pub. No.: US 2012/0194548 A1
(43) Pub. Date: Aug. 2, 2012

(54) SYSTEM AND METHOD FOR REMOTELY SHARING AUGMENTED REALITY SERVICE

(75) Inventor: Kye Hyuk AHN, Bucheon-si (KR)

(73) Assignee: PANTECH CO., LTD., Seoul (KR)

(21) Appl. No.: 13/312,890

(22) Filed: Dec. 6, 2011

(30) Foreign Application Priority Data
Jan. 27, 2011 (KR) 10-2011-0008075

(51) Int. Cl. G09G 5/00

(52) U.S. Cl. 345/633

(57) ABSTRACT

An augmented reality (AR) system and method for remotely sharing an AR service using different markers are provided. The AR system includes a plurality of client devices and a host device. The host device of the AR system may set a sharing area of different makers, and may enable sharing of information included in the sharing area among remotely located client devices. The client device of the AR system may display an AR object identified in the sharing area and may share information related to the AR object through an AR service.

### CROSS-REFERENCE TO RELATED APPLICATION

This application claims priority from and the benefit under 35 U.S.C. §119(a) of Korean Patent Application No. 10-2011-0008075, filed on Jan. 27, 2011, which is incorporated herein by reference for all purposes as if fully set forth herein.

### BACKGROUND

1. Field

This disclosure relates to an augmented reality (AR) system and method, and more particularly to an AR system and method for sharing an AR service.

2. Discussion of the Background

An augmented reality (AR) technology is one form of a virtual reality technology that combines an image of a real world environment, which a user may view through eyes of the user, with virtual world information that may not be readily available in the real world environment to display a combined image. The AR technology may supplement the image of the real world with information available in a virtual world. The AR technology may use a virtual environment created by a computer graphic technique, which may be based on the real world.

The computer graphic technique may provide additional information, which may not be readily available in the real world, to the image of the real world environment. That is, distinguishing between the real world and the virtual world may be difficult at times due to the computer graphic technique overlapping a three-dimensional virtual image having virtual information or an AR object on the real image. Accordingly, the AR technology may immerse the user in the virtual environment so the user may view both the real world environment information and the integrated virtual information. The AR technology may be implemented so that a computer may recognize a predetermined marker and display a three-dimensional graphic model mapped to the marker on a display monitor. Here, the marker may exist on a two-dimensional flat plane, and the marker alone may provide size, direction and location information of a three-dimensional graphic model mapped to the marker to an output device including a monitor. The marker and the three-dimensional graphic model may vary depending on selection of the user.

Conventionally, the marker-based AR technology enables users to apply a three-dimensional graphic model of each user to a marker. However, the marker-based AR technology does not provide sharing of an AR service between users separated by a distance.

### SUMMARY

Exemplary embodiments of the present invention provide an augmented reality (AR) system and method for remotely sharing an AR service.

Additional features of the invention will be set forth in the description which follows, and in part will be apparent from the description, or may be learned by practice of the invention.

Exemplary embodiments of the present invention provide a client device of an augmented reality (AR) system, the client device including a communication unit to exchange data with a host device, a sharing unit to transmit information related to a marker and information related to an AR object to the host device, and to receive information related to a sharing area from the host device, a detection unit to detect the marker in an image, an area tracking unit to identify a sharing area in the marker using the information related to a sharing area, an engine unit to generate an AR object included in the identified sharing area, and to display the AR object, and an AR executing unit to provide an AR service to provide information related to the AR object.

Exemplary embodiments of the present invention provide a host device of an AR system, the host device including a communication unit to exchange data with client devices, a sharing area setting unit to set a sharing area corresponding to an area where a common AR service is provided to client devices participating in an AR session, if the sharing area setting unit receives the information related to the marker from the client devices participating in the AR session, and a sharing unit to enable information related to the sharing area and information related to an AR object among the client devices participating in the AR session.

Exemplary embodiments of the present invention provide a method for remotely sharing an AR service in a client device, the method including transmitting information related to a marker and information related to an AR object to a host device, receiving information related is to a sharing area from the host device, obtaining an image of a real world environment, detecting the marker in the image, identifying a sharing area in the marker, generating an AR object identified in the sharing area, in which the AR object corresponds to the marker, and displaying the AR object in the sharing area, and executing an AR service to provide information related to the AR object.

Exemplary embodiments of the present invention provide a method of remotely sharing an AR service in a host device, the method including capturing information related to a marker comprised in a session generation request message, requesting a generation of an AR session, starting the AR session, determining whether a participation of a client device in the AR session is authorized, transmitting information about whether the participation is authorized to the client device, receiving information related to the markers from the client device participating in the AR session, setting a sharing area corresponding to a common area where a common AR service is provided to client devices participating in the AR session using the received information related to the markers, and enabling information related to the sharing area and information related to an AR object to be shared among the client devices participating in the AR session.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further is understanding of the invention and are incorporated in and constitute a part of this specification, illustrate embodiments of the invention, and together with the description serve to explain the principles of the invention.

FIG. 1 is a diagram illustrating an augmented reality (AR) system according to an exemplary embodiment of the invention.

FIG. 2 is a block diagram illustrating a host device in an AR system according to an exemplary embodiment of the invention.

FIG. 3 is a block diagram illustrating a client device in an AR system according to an exemplary embodiment of the invention.

FIG. 4 is a diagram illustrating a sharing area setting between different markers in an AR system according to an exemplary embodiment of the invention.

FIG. 5 is a flowchart illustrating a method for generating an AR session in a client device of an AR system according to an exemplary embodiment of the invention.

FIG. 6 is a flowchart illustrating a method for participating in an AR session in a client device of an AR system according to an exemplary embodiment of the invention.

FIG. 7 is a flowchart illustrating a method for remotely executing an AR service in a client device of an AR system according to an exemplary embodiment of the invention.

FIG. 8 is a flowchart illustrating a method for remotely providing an AR service in a host device of an AR system according to an exemplary embodiment of the invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity, illustration, and convenience.

Exemplary embodiments of the present invention may relate to an augmented reality (AR) system and method for enabling sharing an AR service among client devices using different markers.

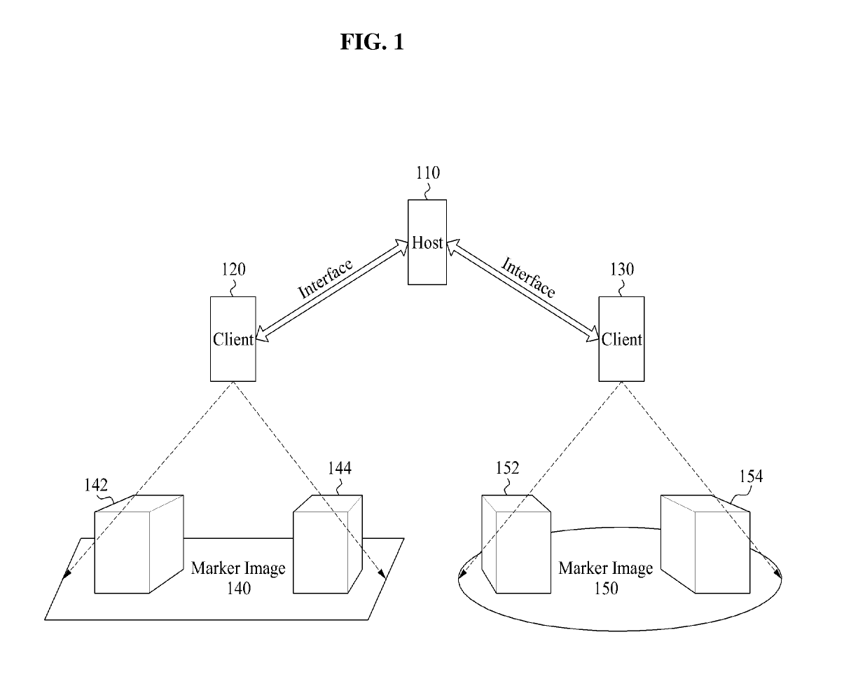

FIG. 1 is a diagram illustrating an AR system according to an exemplary embodiment of the invention.

As shown in FIG. 1, the AR system includes a host device 110, multiple client devices including a client device 120 and a client device 130, and multiple marker images including a marker image 140 and a marker image 150. The host device 110 may set a sharing area for the marker image 140 and the marker image 150, and enable separately located client device 120 and client device 130 to share an AR service by sharing information related to the marker included in the set sharing area. According to aspects of the invention, the marker image 140 and the marker image 150 may have different shapes. However, a portion of the marker image 140 and a portion of the marker image 150 may include similar information or AR objects. The portions of the different marker images having similar information or AR objects is may be set to be shared as a sharing area, such that information or AR objects falling within the sharing area of the marker image may be shared with other client devices.

According to aspects of the invention, the marker image 140 may include AR object 142, AR object 144, and AR object AB (not pictured), and the marker image 150 may include AR object 152, AR object 154, and AR object BC (not pictured). If the host device 110 sets a sharing area for marker image 140, which may include AR object 142 and AR object 144 but not AR object AB, and for marker image 150, which may include AR object 152 and AR object 154 but not AR object BC, only the AR objects included in the sharing area may be shared. Accordingly, AR object 142, AR object 144, AR object 152, and AR object 154 may be shared in this scenario.

According to aspects of the invention, a client device may refer to a terminal that may be able to communicate with other devices using a communication network. The client device may include a mobile terminal, a cellular phone, a smart phone, a laptop, a tablet computer, a personal digital assistant (PDA), and the like. A marker image may refer to an image of a real world environment, which may include one or more markers as well as associated AR objects. For example, the marker may refer to an object that may exist in a real world environment, such as a Starbucks® coffee shop. Further, the marker may be identified by the client device and/or the host device based on one or more marker identification information related to the marker. The marker identification information may include without limitation, a name, a trademark, a symbol, or any other distinguishing characteristic that may be used to identify the marker. The AR object may refer to a virtual image or a virtual object, which may provide virtual information related to the marker. The virtual information may include without limitation, hours of operation, address, promotion information, phone number, customer rating, is customer reviews and the like.

According to aspects of the invention, the host device 110 may be a server or other similar device. The host device 110 may be configured as an independent device, which may communicate with the client device 120 and client device 130 using a wired and/or wireless communication network, or may be configured to be included in a client device. Initially, the client device 120 may have information related to a marker image 140, which may be transmitted to the host device 110 to be shared with the client device 130.

The client device 120 may share the information included in the sharing area of the marker image 140 using the host device 110. More specifically, the client device 120 may transmit information related to the marker image 140 to the host 110, and the host device 110 may set a sharing area for the marker image 140. According to aspects of the invention, the sharing area may be set based on the received information from the client device 120 as well as the information related to the marker image 150, which may be received from the client device 130. The information included in the set area of the marker image 140 may be received by the client device 130 using a communication network to display the AR object 142 and the AR object 144 of the marker image 140 in a preview image. Further, the client device 120 may receive information included in the sharing area of the marker image 150 from the client device 130 using the host device 110.

Similarly, the client device 130 may share the information included in the sharing area of the marker image 150 with the client device 120 to provide shared information (e.g., AR object 152, and AR object 154) to the client device 120 using the host device 110. Further, the client device 130 may receive information included in the sharing area of the marker image 140 from the client device 120 using the host device 110. Accordingly, the client device 130 may is display the marker image 140 and the AR objects 142 and 144 included in the sharing area of the marker image 140 in a preview image.

The information included in the sharing area of the marker image 140 may include AR object 142 and AR object 144. The information included in the sharing area of the marker image 150 may include AR object 152 and AR object 154. Accordingly, if the host 110 shares the received information, which may be included in the set sharing area of the marker image 140 and the marker image 150, the client device 120 may share the marker image 140, the AR object 142 and the AR object 144, and the client device 130 may share the marker image 150, the AR object 152 and the AR object 154. As a result, the client device 120 may be provided with the information related to the marker image 140, the marker image 150, or both marker images. Similarly, the client device 130 may be provided with the information related to the marker image 140, the marker image 150, or both marker images.

Further, if the client device 130 captures a marker image on its own, before the client device 120 shares information related to the similar but different marker image with the client device 130, the shared marker image may provide the captured marker image with supplementary information or replace information related to a portion of the captured marker image included in the sharing area of the shared marker image. According to aspects of the invention, the client device 130 may capture a marker image A before the client device 120 shares information related to a marker image A′ with client device 130, in which the marker image A and marker image A′ may be similar but different marker images. If the marker image A includes AR object A1 in the sharing area but not AR object A2, and the marker image A′ includes AR object A1 and AR object A2 in the sharing area, the client device 120 may provide AR object A2 as supplementary information. Further, if the AR object A1 is updated after the is client device 130 captures the marker image, the updated portion of the AR object A1 may be provided as supplementary information or the entire AR object A1 may be provided to replace the outdated AR object A1.

According to aspects of the invention, the information included in the sharing areas of the marker image 140 and the marker image 150 may be shared. More specifically, the information included in the sharing area of the marker image 140 may be the information included in the sharing area of the marker image 150 that was transmitted by the client device 130 through the host device 110. As a result, the client device 120 and the client device 130 may have same or similar information included in the sharing areas of the marker images. Accordingly, the AR object 142 may correspond to the AR object 152, and the AR object 144 may correspond to the AR object 154 but are displayed through different client devices.

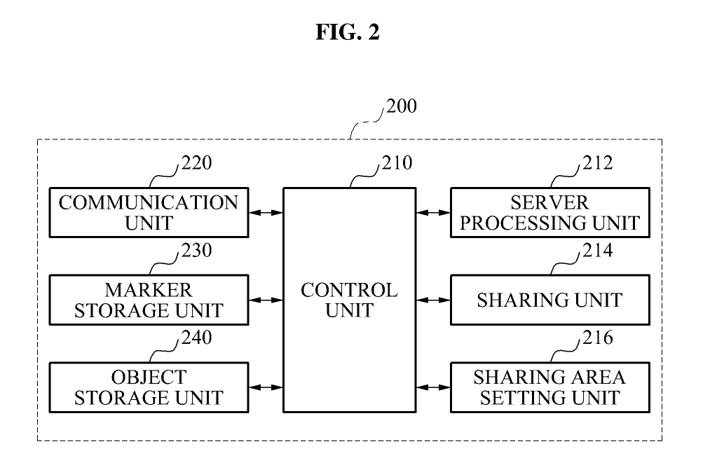

FIG. 2 is a block diagram illustrating a host device in an AR system according to an exemplary embodiment of the invention.

Referring to FIG. 2, the host device 200 includes a control unit 210, a communication unit 220, a marker storage unit 230, an object storage unit 240, a host processing unit 212, a sharing unit 214, and a sharing area setting unit 216.

The communication unit 220 may transmit and receive data to and from one or more client devices using a communication network. The communication network may include a wired network connection, a wireless network connection, and the like.

The marker storage unit 230 may store information related to a marker and information related to the sharing area set through the sharing area setting unit 216. The information related to the marker may include at least one of an image of the marker, identification information of a marker capable of identifying the marker, and characteristic is information used for tracking and/or identifying a location of the marker or the client device. According to aspects of the invention, the information related to the marker may be preset, stored, and/or may be received from a client device, a host device, or a third party device using the communication device 220.

The object storage unit 240 may store information related to an AR object. The AR object may correspond to a marker or an AR service.

According to aspects of the invention, the information related to the marker and the information related to the AR object may be preset, stored, and/or may be received from a client device, a host device, or a third party device using the communication unit 220.

The sharing area setting unit 216 may set a sharing area of a marker used by the client devices participating in an AR session. The sharing area setting unit 216 may reset the sharing area in response to a participation of a new client device using a new marker in the AR session. Further, the sharing area may be reset in response to receiving a user input, one or more reference conditions being met, lapse of reference time period, and the like.

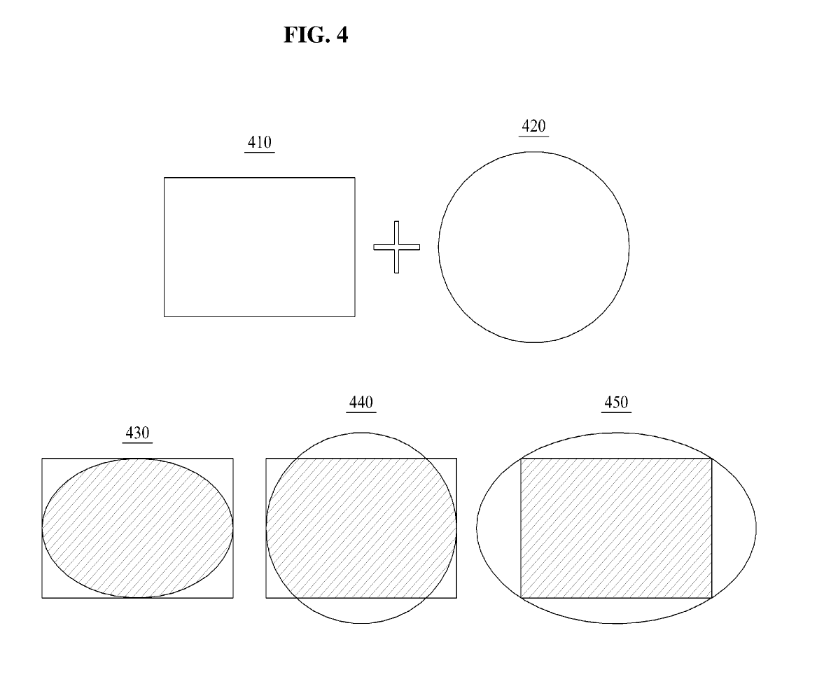

The sharing area setting unit 216 may set a sharing area of different markers as illustrated in FIG. 4.

FIG. 4 is a diagram illustrating a sharing area setting between different markers in an AR system according to an exemplary embodiment of the invention.

Referring to FIG. 4, a first marker 410 and a second marker 420 are illustrated. According to aspects of the invention, a portion of the first marker 410 and the second 420 may be similar and may be set as a sharing area. The sharing area setting unit 216 may analyze the first marker 410 and the second marker 420 to set a sharing area as illustrated by the shaded portions of a sharing area 430, a sharing area 440, and a sharing 450.

The sharing unit 214 may relay information related to a sharing area set by the sharing area setting unit 216 and/or information related to an AR object to be shared among client devices participating in the AR session. The sharing unit 214 may provide one or more client devices participating in the AR session with the information related to a sharing area and/or the information related to an AR object so that client devices participating in the AR session may have access to the same or similar information included in the sharing area and/or the same or similar information related to an AR object. If a client device among client devices participating in the AR session additionally includes or changes information related to an AR object, the sharing unit 214 may provide one or more client devices participating in the AR session with the additionally included or changed information related to the AR object. Further, if the sharing area changes due to a new client device additionally participating in the AR session, the sharing unit 214 may provide one or more client devices participating in the AR session with information related to the changed sharing area. Accordingly, relevant information, such as information related to the marker and/or the AR object included in the sharing area, may be synchronized between two or more client devices participating in the AR session.

The host processing unit 212 may receive a session generation request message from a client device initiating an AR session or an AR initiating client device. Further, the host processing unit 212 may also obtain relevant information from the AR initiating client device, determine whether to accept the session request, and start an AR session with the AR initiating client device. The relevant information may include, without limitation, information related to a sharing area, and information related to a marker or an AR object included in a sharing area. If the host processing unit 212 receives a session generation request message from the AR initiating client device requesting a generation of an AR session, the host processing unit 212 may check is the information related to a marker and/or an AR object that may be included in the session generation request message. If such information is available and/or adequate, the host processing unit 212 may accept the session generation request and may start an AR session with the AR session initiating client device.

Further, the host processing unit 212 may also initiate an AR session by transmitting an AR session generation request message to a client device to establish an AR session.

In addition, if an invitation list is included in the AR session generation request message, the sharing unit 214 may transmit information about the established AR session to client devices that may be included in the invitation list or invited client devices. Accordingly, the invited client devices in the invitation list may view which client devices may have accepted to establish an AR session with the AR session initiating client device. The invitation list may include some or all of the client devices that may have received the AR session generation request message from the AR session initiating client device.

If the sharing unit 214 receives a request for information about an AR session from a client device, the sharing unit 214 may transmit the information about an AR session to the requesting client device. Also, the sharing unit 214 may provide the information about the AR session to the requesting client device through a server to which the client device may access, by transmitting the information about an AR session to the server.

According to aspects of the invention, the information about an AR session may include, without limitation, at least one of an image of a marker, information related to a marker, information related to a sharing area, a participant list, information related to an AR service to be executed, a start time of the AR session, an end time of the AR session, and a log record of the AR session.

If the host processing unit 212 receives a session participation request message from a client device requesting a participation in the AR session or a requesting client device, the host processing unit 212 may determine whether a participation of the requesting client device is authorized, and transmit the result of that determination to the requesting client device. The determination of whether the requesting client device is authorized to participate in the AR session may be based on the participation setting information.

Determination of whether the participation of the requesting client device is authorized may be based on one or more reference conditions being satisfied, a determination by the AR session initiating client device requesting a generation of the AR session, or based on an input of one or more client devices currently participating in the AR session or member client devices.

The control unit 210 may control one or more operations of the host device 200. The control unit 210 may control the operations of the host processing unit 212, the sharing unit 214, and the sharing area setting unit 216. The control unit 210, the host processing unit 212, the sharing unit 214, and the sharing area setting unit 216 are separately illustrated to describe each operation separately for ease of description but the operation of individual components may be integrated in practice. Thus, the control unit 210 may include at least one processor configured to perform each operation of the host processing unit 212, the sharing unit 214, and the sharing area setting unit 216. The control unit 210 may include at least one processor configured to perform a portion of each operation of the host processing unit 212, the sharing unit 214, and the sharing area setting unit 216.

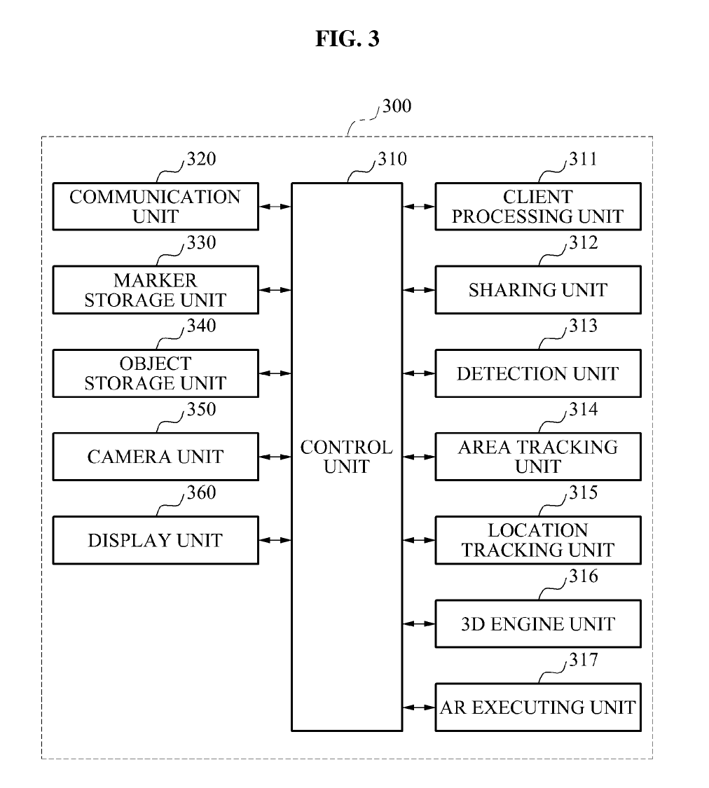

FIG. 3 is a block diagram illustrating a client device in an AR system according to is an exemplary embodiment of the invention.

Referring to FIG. 3, the client device 300 includes a control unit 310, a communication unit 320, a marker storage unit 330, an object storage unit 340, a camera unit 350, a display unit 360, a client processing unit 311, a sharing unit 312, a detection unit 313, an area tracking unit 314, a location tracking unit 315, a three-dimensional (3D) engine unit 316, and an AR executing unit 317.

The communication unit 320 may transmit and receive data to and from the host device or other client device using a communication network. The communication network may include a wired connection network, a wireless connection network, and the like.

The marker storage unit 330 may store information related to a marker and information related to a sharing area. The information related to a marker may include at least one of an image of the marker, identification information of a marker capable of identifying a marker, and characteristic information used to identify a location of the marker or the client device. The information related to the sharing area may include, without limitation, size information of the AR object identified in the sharing area and/or size information of the sharing area.

According to aspects of the invention, the information related to a marker may be preset, stored, and/or received from the host device through the communication unit 320. The information related to a sharing area may correspond to information received from the host device through the communication unit 320.

The object storage unit 340 may store information related to an AR object corresponding to a marker, a sharing area, or an AR service.

The camera unit 350 may correspond to a device taking or capturing an image, and may provide the captured image to the detection unit 313 and the display unit 360. According to aspects of the invention, the captured image or the preview image may be corrected through an image correction or a camera correction process before being provided to the detection unit 313 and/or the display unit 360.

The display unit 360 may display status information or an indicator about a state occurring during an operation of the client device 300, numbers, figures, characters, a moving picture, a still picture, and the like. The display unit 360 may display an image or a marker received through the camera unit 350, and a corresponding AR object generated in the 3D engine unit 316.

The sharing unit 312 may share information related to a marker and information related to an AR object with another client device and the host device in the AR session.

The detection unit 313 may detect a marker in a preview image or an image captured using the camera unit 350.

The area tracking unit 314 may track a sharing area in a marker taken in the preview image, using information related to the sharing area.

The location tracking unit 315 may track a location of a client device or the marker based on one or more characteristic information of the marker. More specifically, the characteristic information of the marker may be identified in the captured image, and based on that characteristic information the location of the marker may be identified. The characteristic information may include, without limitation, an address, geographic coordinate information, telephone number, and other information that may aid in identifying the location of the marker.

The 3D engine unit 316 may generate an AR object corresponding to the identified marker, which may be based at least in part on the identified location of the marker or is the client device, and may display the generated AR object in the sharing area based on the location of the marker or the client device. According to aspects of the invention, the AR object may be generated in a 3D or a 2D format.

The AR executing unit 317 may execute an AR service to provide the AR object information to the member client devices. Further, the AR executing unit 317 may enable sharing of information related to an additionally included or changed AR object through the sharing unit 312. Further, if the information related to the respective AR object is changed before or during an AR session the information related to the changed AR object may be shared with the member client devices.

If the client processing unit 311 detects an occurrence of an event of generating an AR session, the client processing unit 311 may retrieve information related to the marker, which may be stored in a host device or a client device or provided by a user input. Further, the client processing unit 311 may transmit an AR session generation request message requesting generation of the AR session, which may include the information related to the marker to the host device.

If the client processing unit 311 receives a session participation request message from a client device, which requests participation in an existing AR session, the client processing unit 311 may determine whether the requesting client device may participate in the AR session. The client processing unit 311 may determine whether to allow the requesting client device to participate based on a user input, input of users of other member client devices in the AR session, and/or one or more reference conditions. The result of the participation determination of the requesting client device may be transmitted to the requesting client device that transmitted the session participation request message. The client processing unit 311 may transmit result of is the participation determination of the requesting client device to the requesting client device through the host device.

If the client processing unit 311 detects an occurrence of an event of participating in the AR session, the client processing unit 311 may acquire information about the AR session from the host device, and may transmit a session participation request message, which may request participation in the existing AR session to the host device.

Further, the client processing unit 311 may also receive a session invitation message from the host device. In response, the client processing unit 211 may acquire the information about the AR session from the session invitation message. In addition, the client processing unit 311 may acquire the information about the AR session by requesting the host device or a server managing the AR session in order to obtain information about the AR session.

According to aspects of the invention, the information about the AR session may include, without limitation, at least one of an image of the marker, information related to the marker, information related to the sharing area, a participant list, information related to an AR service to be executed, a start time of the AR session, an end time of the AR session, and a log record of the AR session.

The control unit 310 may control one or more operations of the client device 300. The control unit may control the operation of the client processing unit 311, the sharing unit 312, the detection unit 313, the area tracking unit 314, the location tracking unit 315, the 3D engine unit 316, and the AR executing unit 317. The control unit 310, the client processing unit 311, the sharing unit 312, the detection unit 313, the area tracking unit 314, the location tracking unit 315, the 3D engine unit 316, and the AR executing unit 317 are separately illustrated to describe each operation separately for ease of description but the operation of individual components may be is integrated in practice. Thus, the control unit 310 may include at least one processor configured to perform operations of the client processing unit 311, the sharing unit 312, the detection unit 313, the area tracking unit 314, the location tracking unit 315, the 3D engine unit 316, and the AR executing unit 317. Also, the control unit 310 may include at least one processor configured to perform a portion of each operation of the client processing unit 311, the sharing unit 312, the detection unit 313, the area tracking unit 314, the location tracking unit 315, the 3D engine unit 316, and the AR executing unit 317.

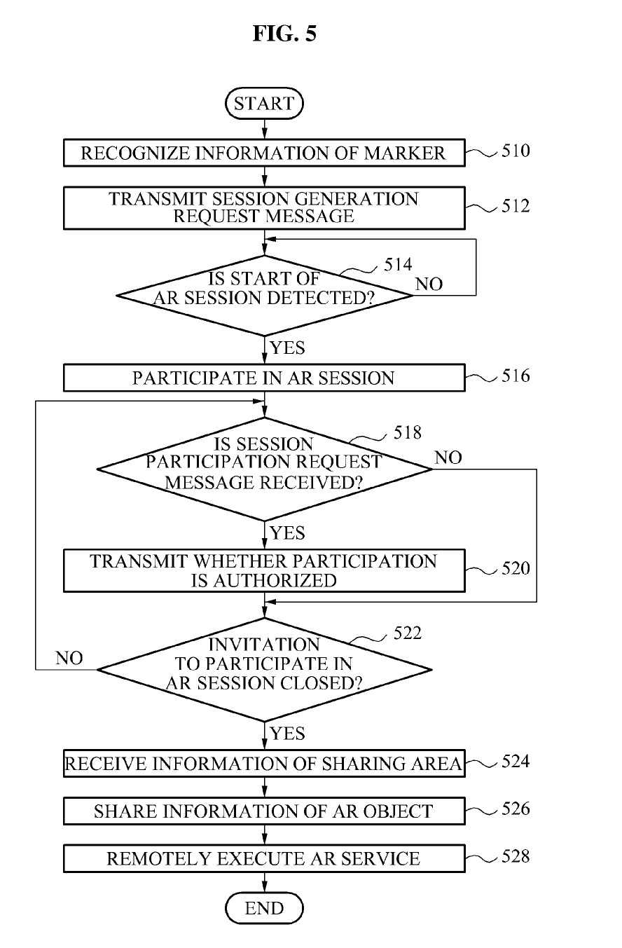

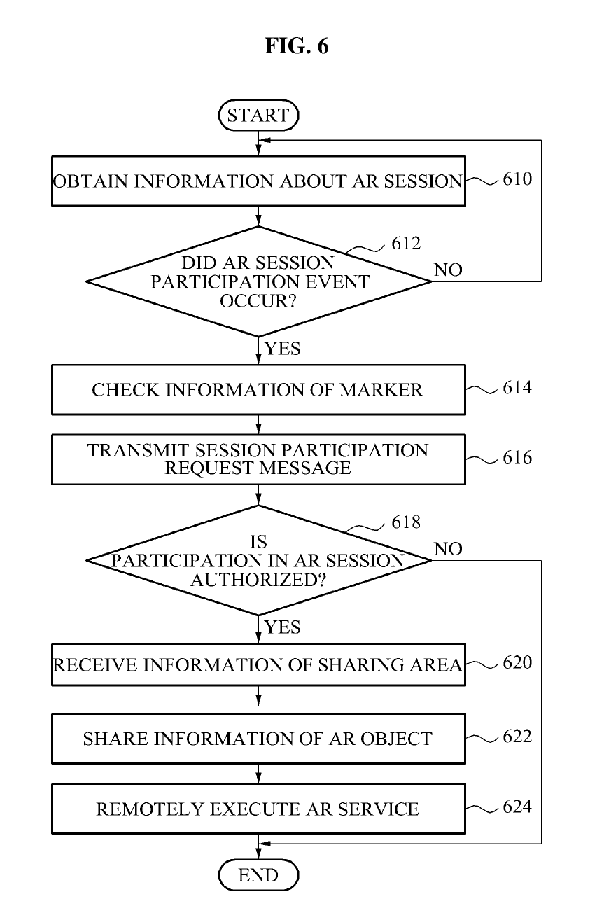

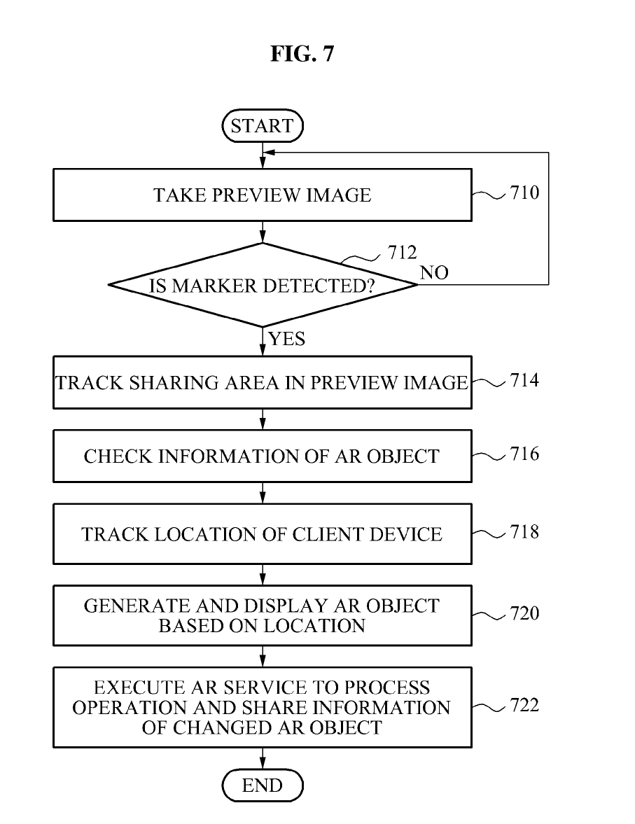

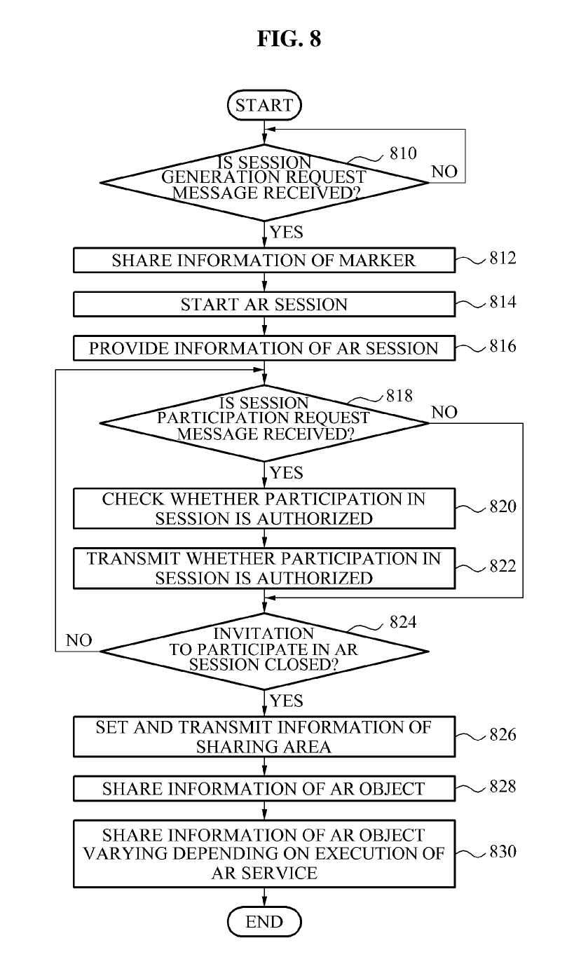

Hereinafter, methods for remotely sharing an AR service using different markers are disclosed with reference to FIG. 5, FIG. 6, FIG. 7, and FIG. 8 below. For convenience, FIG. 5, FIG. 6, FIG. 7, and FIG. 8 will be described as if the method was performed by the AR system and its components (e.g., client device and host device) described above. However, aspects of the invention are not limited as such.

FIG. 5 is a flowchart illustrating a method for generating an AR session in a client device of an AR system according to an exemplary embodiment of the invention.

Referring to FIG. 5, the client device may recognize information related to a marker in operation 510, such as an AR object, and may transmit a session generation request message to request a generation of an AR session to a host device in operation 512. Further, the session generation request message may also include an invitation list corresponding to a list of client devices that may be invited to participate in the AR session. The session generation request message may include information related to the marker and a corresponding AR object.

If a different client device detects a start or existence of the AR session by the host device in operation 514, the client device may seek to participate in the AR session in operation 516. The start or the existence of the AR session may be detected by receiving a is session invitation message, from the host device, inviting the client device to join the AR session. The session invitation message may include, without limitation, information about the AR session, which may include at least one of information related to a marker, information related to a sharing area, a participant list, information related to an AR service to be executed, a start time of the AR session, an end time of the AR session, and a log record of the AR session. The information related to the sharing area may be included in the information about the AR session, and may be separately received from the host device in a subsequent operation.

If the AR session initiating client device receives the session participation request message from a requesting client device, which requests participation in the AR session, through the host device in operation 518, the AR session initiating client device may determine whether participation of the requesting client device in the AR session is authorized. The determination of whether the participation of the requesting client device is authorized may be based on a user input, input of users of other member client devices in the AR session, and/or one or more reference conditions. The result of the participation determination of the requesting client device may be transmitted to the requesting client device through the host device in operation 520.

If the AR session initiating client device does not receive a session participation request message from another client device or a requesting client device, the AR session initiating client device may skip operation 520 and proceed to operation 522. In addition, operation 518, operation 520, and operation 522 may not be performed in the client device and may be performed in the host device. Further, operation 518, operation 520, and operation 522 may be omitted.

In operation 522, the AR session initiating client device may determine whether the client device's invitation to participate in the AR session remains open or closed. If the is invitation to participate in the AR session remains open as a result of the determination in operation 522, the AR session initiating client device may return to operation 518. The participation in the AR session may be determined to be completed if one or more reference conditions are satisfied, if a user makes a request to close out outstanding invitations to the AR session, or if all of the client devices in the invitation list that were invited to participate in the AR session have responded to the invitation. The invited client devices may respond to participate in the AR session or deny the invitation to participate. According to aspects of the invention, the reference condition for determining whether the invitation to participate in the AR session remains open may include, without limitation, the lapse or expiration of an invitation, obtaining minimum number of participants, obtaining maximum number or participants, participating by a reference number of client devices, lapse of reference period of time of the AR session, and the like.

If the invitation to participate in the AR session is closed out or no longer open in operation 522, the client device may receive information related to the sharing area from the host device in operation 524. According to aspects of the invention, the information related to the sharing area may be included in the session invitation message, which is received in operation 524. Based on the received information related to the sharing area, a sharing area within the marker may be identified.

In operation 526, the client device may share information related to an AR object included in the sharing area with some or all member client devices participating in the AR session. The information related to the AR object included in the sharing area may be shared with some or all member client devices participating the AR session through the host device.

In operation 528, the AR session initiating client device may remotely execute an AR service and share the AR service with other member client devices. Accordingly, if the information related to the AR object included in the sharing area is determined to have changed according to the AR service, the AR session initiating client device (or other member client device) may share the changed information with the member client devices participating in the AR session.

FIG. 6 is a flowchart illustrating a method for participating in an AR session in a client device of an AR system according to an exemplary embodiment of the invention.

Referring to FIG. 6, in operation 610, a client device may acquire information about an existing AR session. The AR session may already be in session. The client device may obtain information about the AR session by receiving a session invitation message from the host device. The session invitation message may include information about the AR session. The client device may acquire the information about the AR session by requesting a host device or a server managing the AR session for the information about the AR session.

If the client device detects an occurrence of an AR session participation event in operation 612, the client device may check or capture information related to a marker to be used in the client device in operation 614.

In operation 616, the client device may transmit a session participation request message, requesting a participation in the AR session, to the host device. The session participation request message may include the captured information related to the marker.

In operation 618, the requesting client device may determine whether the participation in the AR session is authorized. Whether participation in the AR session is authorized may be determined based on one or more reference conditions being satisfied, a decision by the AR session initiating client device requesting a generation of the AR session, or is opinions of member client devices currently participating in the AR session.

If the participation in the AR session is determined not to be authorized in operation 618, the process may terminate.

If the participation in the AR session is determined to be authorized in operation 618, the requesting client device may receive information related to the sharing area in operation 620.

In operation 622, the requesting client device may remotely execute an AR service to share information related to the AR object included within the sharing area of the marker with some or all client devices participating in the AR session. According to aspects of the invention, the information related to the AR object included in the sharing area may be shared with some or all client devices participating in the AR session through the host device.

In operation 624, the requesting client device may remotely execute an AR service and share an AR service with other member client devices.

FIG. 7 is a flowchart illustrating a method for remotely executing an AR service in a client device of an AR system according to an exemplary embodiment of the invention.

Referring to FIG. 7, in operation 710, a client device may take or capture a preview image or an image.

In operation 712, the client device may detect a marker in the taken or captured preview image or image. If the marker is not detected in the preview image or the image as a result of operation 712, the client device may return to operation 710.

If the marker is detected in the preview image as a result of operation 712, the client device may track or identify a sharing area in the marker included in the preview image, using information related to the sharing area in operation 714.

In operation 716, the client device may check or retrieve information related to an AR object, which may be included in the identified sharing area of the marker. The AR object may correspond to the marker, the sharing area, and/or the AR service.

In operation 718, the client device may track or identify its location or the location of the marker using a characteristic of the marker.

In operation 720, the client device may generate an AR object based on the tracked or identified location, and display the generated AR object on a display screen.

In operation 722, the client device may execute or provide an AR service to provide additional or changed information related to the AR object included in the sharing area. Further, the client device may share the additional or changed information related to the changed AR object included in the sharing area with other member client devices participating in the AR session. Accordingly, the member client devices having the same or similar AR objects included in the sharing area of the marker may have the same or similar updated information related to the AR object.

FIG. 8 is a flowchart illustrating a method for remotely providing an AR service in a host device of an AR system according to an exemplary embodiment of the invention.

Referring to FIG. 8, if the host device receives a session generation request message from a client device requesting a generation of an AR session or an AR session initiating client device in operation 810, the host device may share information related to a marker with the AR session initiating client device in operation 812. The information related to the marker may be included in the session generation request message.

In operation 814, the host device may start an AR session. In operation 816, the host device may provide information about the AR session to other member client devices that is may participate in the AR session.

To provide information about the AR session, the host device may transmit the information about the AR session to client devices included in an invitation list, if the invitation list is included in the session generation request message.

If the host device receives a request for the information about the AR session from a client device, the host device may transmit the information about the AR session to the requesting client device. The host device may provide the information about the AR session to the requesting client device, or a server accessed by the requesting client device by transmitting the information about the AR session to a server to which the client device may access.

According to aspects of the invention, the information about the AR session may include, without limitation, at least one of an image of the marker, information related to the marker, a participant list, information related to an AR service to be executed, a start time of the AR session, an end time of the AR session, and a log record of the AR session.

If the host device receives a session participation request message, requesting a participation in the AR session, from the requesting client device in operation 818, the host device may determine whether participation of the requesting client device is authorized in operation 820.

The determination of whether the participation of the requesting client device is authorized may be based on one or more reference conditions, a decision by the AR session initiating client device requesting a generation of the AR session, or opinions of member client device currently participating in the AR session.

In operation 822, the host device may transmit information about whether participation of the client device is authorized to the requesting client device, which transmitted is the session participation request message.

In operation 824, the host device may determine whether the client device's invitation to participate in the AR session remains open or closed. If the invitation to participate in the AR session is determined to remain open in operation 824, the host device may return to operation 818. The participation in the AR session may be determined to be completed if one or more reference conditions are satisfied, if the AR session initiating client device requesting a generation of the AR session controls the invitation to participate in the AR session to close, or if all client devices in the invitation list that were invited to participate in the AR session have responded to the invitation. The invited client devices may respond to participate in the AR session or deny the invitation to participate. According to aspects of the invention, the reference condition of determining whether the invitation to participate in the AR session remains open include, without limitation, the lapse or expiration of an invitation, obtaining minimum number or participants, obtaining maximum number of participants, obtaining a reference number of participants, lapse of reference period of time or duration, and the like.

If the invention to participate in the AR session is closed out or no longer open in operation 824, the host device may set a sharing area corresponding to a common area where a common AR service may be provided to member client devices participating in the AR session. Further, the sharing area may be set using information related to markers received from the requesting client devices participating in the AR session. The host device may transmit information related to the set sharing area to the member client devices participating in the AR session in operation 826.

In operation 828, the host device may relay information related to an AR object included in the set sharing area to be shared between some or all member client devices is participating in the AR session.

In operation 830, the host device may obtain and relay information related to the AR object included in the set sharing area using the executed AR service. Accordingly, the information related to the AR object, which may be changed or updated with new information, may be shared between some or all member client devices participating in an AR session.

Exemplary embodiments of the present invention relate to an AR system and method for setting a common sharing area for different markers through a host device, sharing information included in the sharing area and information related to an AR object among client devices separated at a long distance, and sharing an AR service among client devices through the host device. According to exemplary embodiments of the present invention, client devices at different locations may be remotely provided an AR service by relaying through a host device, and the AR service may be shared by using different markers since a sharing area may be set between different markers.

The exemplary embodiments according to the present invention may be recorded in non-transitory computer-readable media including program instructions to implement various operations embodied by a computer. The non-transitory computer-readable media may also include, alone or in combination with the program instructions, data files, data structures, and the like. The non-transitory computer-readable media and program instructions may be those specially designed and constructed for the purposes of the present invention, or they may be of the well-known variety and available to those having skill in the computer software arts. Examples of non-transitory computer-readable media include magnetic media such as hard disks, floppy disks, and magnetic tape; optical media such as CD ROM discs and DVD; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents

What is claimed is:

1. A first client device of an augmented reality (AR) system, the first client device comprising:
a communication unit to exchange data with a host device;
a sharing unit to transmit information related to a marker and information related to an AR object to the host device, and to receive information related to a sharing area from the host device;
a detection unit to detect the marker in an image;
an area tracking unit to identify a sharing area in the marker using the information related to a sharing area;
an engine unit to generate an AR object included in the identified sharing area, and to display the AR object; and
an AR executing unit to provide an AR service to provide information related to the AR object.

2. The first client device of claim 1, wherein the sharing area corresponds to a common area of a marker, where client devices participating in an AR session provide a common AR service.

3. The first client device of claim 1, wherein the information related to the sharing area comprises at least one of size information of the AR object included in the sharing area, and size information of the sharing area.

4. The first client device of claim 3, wherein the engine unit sets a size of the displayed AR object based on the information related to the AR object or the size information related to the AR object.

5. The first client device of claim 1, further comprising:
a location tracking unit to identify a location of the marker, using a characteristic of the marker comprised in the information related to the marker,
wherein the engine unit generates the AR object corresponding to the marker based on the identified location of the marker and displays the AR object.

6. The first client device of claim 1, further comprising:
a client processing unit to retrieve the information related to the marker, wherein the information related to the marker is stored or received from the first client device, and to transmit a session generation request message to the host device, wherein the session generation request message requests generation of an AR session and comprises the information related to the marker.

7. The first client device of claim 6, wherein, in response to a reception of a session participation request message from a second client device, requests participation in the AR session.

8. The first client device of claim 7, wherein the client processing unit transmits a determination of whether the participation is authorized to the second client device.

9. The first client device of claim 1, further comprising:
a client processing unit to obtain information about an AR session from the host device, and to transmit a session participation request message to the host device.

10. The first client device of claim 9, wherein the client processing unit receives a session invitation message from the host device, and acquires the information about the AR session from the session invitation message.

11. The first client device of claim 9, wherein the client processing unit requests and acquires the information about the AR session from the host device or a sever managing the AR session.

12. The first client device of claim 9, wherein the information about the AR session comprises at least one of the information related to the marker, the information related to the sharing area, a participant list, information related to an AR service to be executed, a start time of the AR session, an end time of the AR session, and a log record of the AR session.

13. A host device of an augmented reality (AR) system, the host device comprising:
a communication unit to exchange data with client devices;
a sharing area setting unit to set a sharing area corresponding to an area where a common AR service is provided to client devices participating in an AR session, if the sharing area setting unit receives information related to a marker from the client devices participating in the AR session; and
a sharing unit to enable sharing of information related to the sharing area and information related to an AR object among the client devices participating in the AR session.

14. The host device of claim 13, wherein the information related to the sharing area comprises at least one of size information of the AR object identified in the sharing area, and size information of the sharing area.

15. The host device of claim 13, wherein:
the sharing area setting unit resets the sharing area in response to a new client device participating in the AR session, and
the sharing unit enables information related to the reset sharing area to be shared among the client devices participating in the AR session.

16. The host device of claim 13, wherein the sharing unit transmits information related to a changed AR object to a first client device participating in the AR session, if the sharing unit receives a request to change the AR object from a second client device participating in the AR session.

17. The host device of claim 13, further comprising:
a host processing unit to capture the information related to the markers comprised in a session generation request message, wherein the session generation request message requests generation of the AR session, starts the AR session in response to a reception of the session generation request message.

18. The host device of claim 17, wherein the sharing unit transmits information about the AR session to an invited client device, if the invited client device is identified in the invitation list, wherein the invitation list is comprised in the session generation request message.

19. The host device of claim 17, wherein the sharing unit transmits information about the AR session to a requesting client device, if the sharing unit receives a request for the information about the AR session from the requesting client device.

20. The host device of claim 17, wherein the host processing unit determines whether the participation of a requesting client device is authorized and transmits the result of that determination to the requesting client device, if the host processing unit receives a session participation request message requesting participation in the AR session from the requesting client device.

21. The host device of claim 17, wherein the information about the AR session comprises at least one of the information related to the marker, the information related to the sharing area, a participant list, information related to an AR service to be executed, a start time of the AR session, an end time of the AR session, and a log record of the AR session.

22. A method for remotely sharing an augmented reality (AR) service in a client device, the method comprising:
transmitting information related to a marker and information related to an AR object to a host device;
receiving information related to a sharing area from the host device;
obtaining an image of a real world environment;
detecting the marker in the image;
identifying a sharing area in the marker;
generating the AR object identified in the sharing area, wherein the AR object corresponds to the marker;
displaying the AR object in the sharing area; and
executing an AR service to provide information related to the AR object.

23. A method for remotely sharing an augmented reality (AR) service in a host device, the method comprising:
capturing information related to a marker comprised in a session generation request message;
requesting a generation of an AR session;
starting the AR session;
determining whether a participation of a client device in the AR session is authorized;
transmitting information about whether the participation is authorized to the client device;
receiving information related to the markers from the client device participating in the AR session;
setting a sharing area corresponding to a common area where a common AR service is provided to client devices participating in the AR session using the received information related to the markers; and
enabling information related to the sharing area and information related to an AR object to be shared among the client devices participating in the AR session.
